(19) United States
(12) Patent Application Publication
(10) Pub. No.: US 2025/0344230 A1
(43) Pub. Date: Nov. 6, 2025

(54) DYNAMIC ACCESS AND MOBILITY MANAGEMENT FUNCTION (AMF) SCALING

(71) Applicant: DISH Wireless L.L.C., Englewood, CO (US)

(72) Inventors: Karupaiah Rajendran, Sachse, TX (US); Ahmed Awwad Whdan, Centennial, CO (US)

(21) Appl. No.: 18/652,469

(22) Filed: May 1, 2024

(51) Int. Cl. H04W 72/50

(52) U.S. Cl. CPC H04W 72/50

(57) ABSTRACT

Technologies for dynamic scaling of access and mobility management function (AMF) resources in a cellular network are described. One method include monitoring a plurality of parameters associated with an access and mobility management function (AMF) in the cellular network, the plurality of parameters being associated with a demand on performance of the AMF; dynamically determining, based on the plurality of parameters, a value of a resource parameter of the AMF; and adjusting one or more resources of the AMF according to the value of the resource parameter.

### BACKGROUND

Cellular networks are highly complex. One type of cellular network is a fifth generation (5G) new radio (NR) cellular networks. 5G NR cellular networks have the promise to provide higher throughput, lower latency, and higher availability compared with previous global wireless standards. However, some parameters in a 5G NR cellular network cannot be modified dynamically, which may compromise such promise.

### BRIEF DESCRIPTION OF THE DRAWINGS

The present disclosure is illustrated by way of example, and not by way of limitation, in the figures of the accompanying drawings.

FIG. 1 is a block diagram of a system implementing dynamic scaling of access and mobility management function (AMF) resources in a cellular network according to at least one embodiment.

FIGS. 2 and 3 are block diagrams of systems including AMF resource manager that implements dynamic scaling of AMF resources in a cellular network according to at least one embodiment.

FIG. 4 illustrates example threshold criteria used in dynamic scaling of AMF resources in a cellular network according to at least one embodiment.

FIG. 5 illustrates example resource parameters used in dynamic scaling of AMF resources in a cellular network according to at least one embodiment.

FIGS. 6 and 7 are flow diagrams of example methods of dynamic scaling of AMF resources in a cellular network according to at least one embodiment.

### DETAILED DESCRIPTION

Technologies for dynamic scaling of AMF resources in a telecommunications network, such as a cellular network (e.g., 5G wireless network, 6G wireless network) are described. The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

Conventionally, resources used by certain component (e.g., access and mobility management function (AMF)) of a cellular network are either static or adjusted manually, which may result in an over provision of resources or under provision of resources compared to the demand of resources.

Aspects and embodiments of the present disclosure address the above and other deficiencies by providing a system that implements dynamic scaling of access and mobility management function (AMF) resources in a cellular network. Specifically, a component of the cellular network (e.g., AMF resource manager) may monitor parameters associated with an AMF in the cellular network. The monitored parameters may characterize at least one of: a time point or period, a geographic region associated with a data center including the AMF, the number of user equipment (UE) served by the AMF, the state of each UE, data demand served by the AMF, the number of base stations served by the AMF, the capacity and status of each base station, or traffic in various interfaces to the AMF. The base station (e.g., “gNodeB” or “gNB”) refers to a network element responsible for the transmission and reception of radio signals in one or more cells (or coverage areas) to or from user equipment (UE) and may include centralized units (CUs), distributed units (DUs), and radio units (RUS).

The number of UEs may include the number of subscribers served by the AMF and may be reflected by a (e.g., real-time) count of UE connected to the base stations provided by the AMF. The state of UE may include movement of mobile UE, the transaction mode of UE (e.g., idle mode or connected mode), or proximity (e.g., measured by distance) to the base station. The data demand served by the AMF may include a prediction of data size at a specific time point, for example, based on historical data or based on type of services, such as static or dynamic services, that AMF is handling.

The number of base stations served by AMF may include the number of CUs served by the AMF, the number of DUs served by each CU, the number of cells each DU handles, etc. The capacity and status of each base station may include a CU capacity, a DU capacity, current utilization including resource availability, user throughput, bearer service parameters, etc.

The traffic in various interfaces to AMF may include traffic in interface N12 to authentication server function (AUSF), traffic in interface N8 to unified data management (UDM), interface N11 to session management function (SMF), traffic in interface N15 to policy control function (PCF), traffic in interface N2 to the base station, traffic in evolved packet data gateway (cPDG) connected through non-3Gpp based access network (e.g., untrusted wireless local area networks (WLANs)) to UE, etc. The traffic in various interfaces to AMF may further include traffic in interface N22 to network slice selection function (NSSF), traffic in interface N1 to UE, etc.

The component of the cellular network may dynamically determine, based on the monitored parameters, a value of a resource parameter of the AMF of the cellular network. For example, the component of the cellular network may determine whether one or more monitored parameters satisfy one or more respective threshold criteria for determining one or more new values of resource parameters to adjust the AMF resources. Responsive to determining that one or more monitored parameters satisfy one or more respective threshold criteria, the component of the cellular network may determine the value of the resource parameter of the AMF. In some implementations, the resource parameter comprises at least one of: a capacity of memory, a capacity of storage, the number of CPU, the bandwidth of network interconnection, provided locally (e.g., physically) or in the cloud (e.g., in virtualization). In some implementations, the component of the cellular network may dynamically, based on the monitored parameters, generate a value higher or lower than a preset value of the resource parameter of the AMF. In some implementations, the component of the cellular network may determine, based on the monitored parameters, a value of a resource parameter of the AMF by incrementally increasing or decreasing the value of the resource parameter of the AMF that is currently in use (e.g., a pre-defined incremental value of the resource parameter) or by selecting the value from a set of pre-configured values (e.g., pre-configured values of each resource parameter stored in a data structure).

In some implementations, the component of the cellular network may predict, based on the monitored parameters and/or historical data, a reference value (e.g., a maximum value or a minimum value) of the resource parameter for dynamic determination of the value used to scale up or scale down of resources. In some implementations, the reference value is weighted to be used with the monitored parameters to determine the value of the resource parameter of the AMF.

The cellular network may adjust one or more resources of the AMF according to the value of the resource parameter. In some implementations, the component of the cellular network may configure the AMF using the determined value higher or lower than a default or currently-used value of resource parameter of the AMF. In some implementations, the component of the cellular network may retrieve the corresponding resource package provided by a resource provider and adjust one or more resources of the AMF by using the retrieved resource package.

Aspects and embodiments of the present disclosure can use monitoring and the real-time measurement context of the cellular network for automatic and dynamic control of one or more resources used by an AMF in the cellular network. Aspects and embodiments of the present disclosure can improve system performance and cost-efficiency by providing suitable AMF resources to the demand.

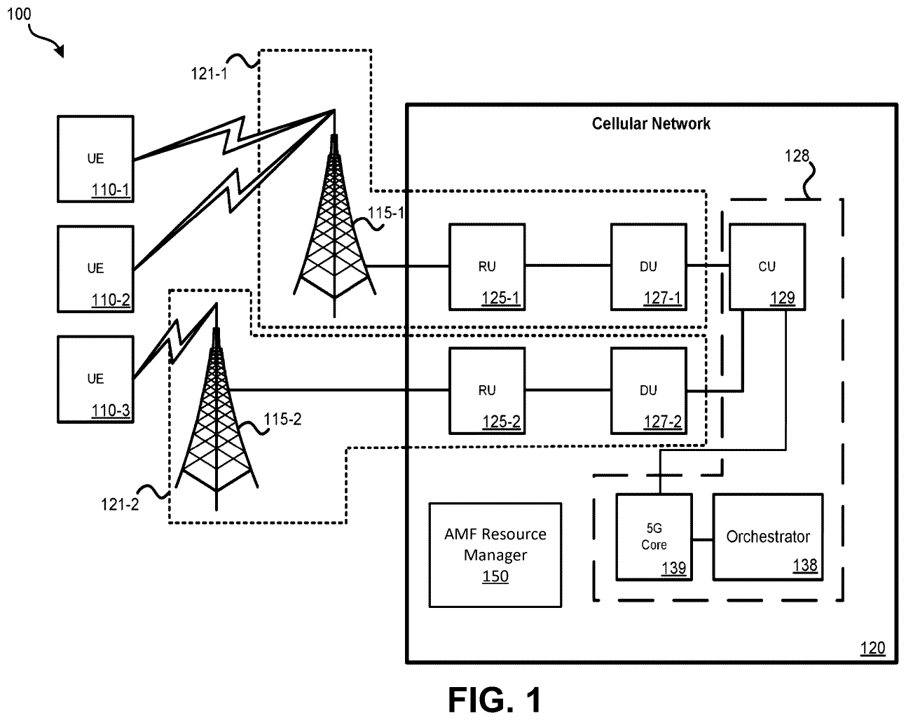

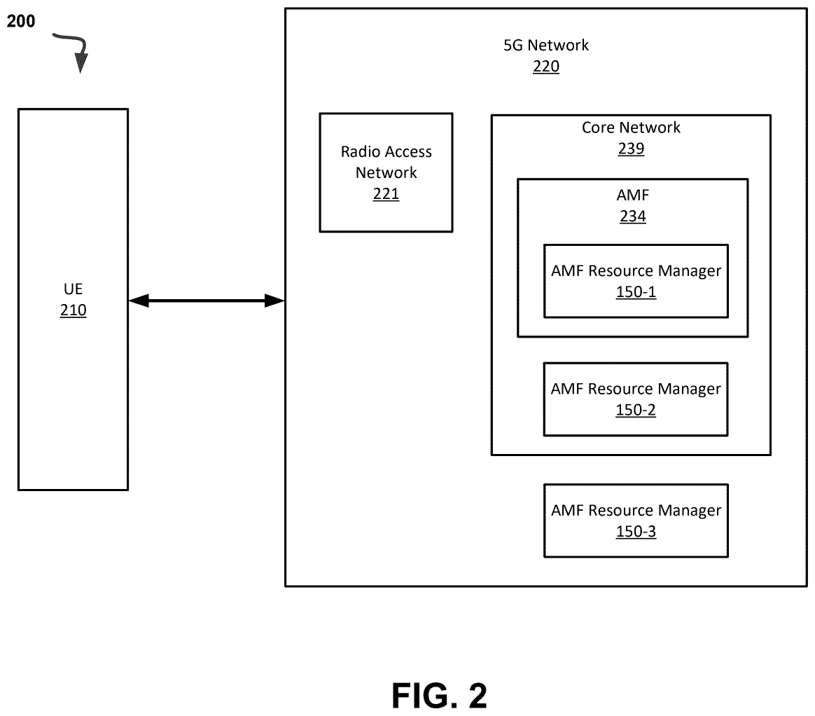

FIG. 1 illustrates an embodiment of a cellular network system 100A (“system 100A”). FIG. 1 represents an embodiment of a cellular network which can accommodate the cloud-based architecture of FIG. 2. System 100A can include a 5G New Radio (NR) cellular network; other types of cellular networks, such as 6G, 7G, etc. may also be possible. System 100A can include: UEs 110 (UE 110-1, UE 110-2, UE 110-3); base station 121; cellular network 120; radio units 125 (“RUs 125”); distributed units 127 (“DUs 127”); centralized unit 129 (“CU 129”); 5G core 139, and orchestrator 138. FIG. 1 represents a component-level view. In an open radio access network (O-RAN), because components can be implemented as specialized software executed on general-purpose hardware, except for components that need to receive and transmit radio frequency (RF), the functionality of the various components can be shifted among different servers. For at least some components, the hardware may be maintained by a separate cloud-service provider, to accommodate where the functionality of such components is needed.

UE 110 can represent various types of end-user devices, such as cellular phones, smartphones, cellular modems, cellular-enabled computerized devices, sensor devices, gaming devices, access points (APs), any computerized device capable of communicating via a cellular network, etc. Generally, UE can represent any type of device that has an incorporated 5G interface, such as a 5G modem. Examples can include sensor devices, Internet of Things (IoT) devices, manufacturing robots; unmanned aerial (or land-based) vehicles, network-connected vehicles, etc. Depending on the location of individual UEs, UE 110 may use RF to communicate with various base stations of cellular network 120. As illustrated, two base stations 121 are illustrated: base station 121-1 can include: structure 115-1, RU 125-1, and DU 127-1. Structure 115-1 may be any structure to which one or more antennas (not illustrated) of the base station are mounted. Structure 115-1 may be a dedicated cellular tower, a building, a water tower, or any other human-made or natural structure to which one or more antennas can reasonably be mounted to provide cellular coverage to a geographic area. Similarly, base station 121-2 can include: structure 115-2, RU 125-2, and DU 127-2.

Real-world implementations of system 100 can include many (e.g., thousands) of base stations (BSs) and many CUs and 5G core 139. Structures 115 can include one or more antennas that allow RUs 125 to communicate wirelessly with UEs 110. RUs 125 can represent an edge of cellular network 120 where data is transitioned to wireless communication. The radio access technology (RAT) used by RU 125 may be 5G New Radio (NR), or some other RAT. The remainder of cellular network 120 may be based on an exclusive 5G architecture, a hybrid 4G/5G architecture, a 4G architecture, or some other cellular network architecture. Base station 121 equipment may include an RU (e.g., RU 125-1) and a DU (e.g., DU 127-1).

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, band 71. One or more DUs, such as DU 127-1, may communicate with CU 129.

Collectively, an RU, DU, and CU create a gNodeB, which serves as the radio access network (RAN) of cellular network 120. CU 129 can communicate with 5G core 139. The specific architecture of cellular network 120 can vary by embodiment. Edge cloud server systems outside of cellular network 120 may communicate, either directly, via the Internet, or via some other network, with components of cellular network 120. For example, DU 127-1 may be able to communicate with an edge cloud server system without routing data through CU 129 or 5G core 139. Other DUs may or may not have this capability.

While FIG. 1 illustrates various components of cellular network 120, other embodiments of cellular network 120 can vary the arrangement, communication paths, and specific components of cellular network 120. While RU 125 may include specialized radio access componentry to enable wireless communication with UE 110, other components of cellular network 120 may be implemented using either specialized hardware, specialized firmware, and/or specialized software executed on a general-purpose server system. In an O-RAN arrangement, specialized software on general-purpose hardware may be used to perform the functions of components such as DU 127, CU 129, and 5G core 139. Functionality of such components can be co-located or located at disparate physical server systems. For example, certain components of 5G core 139 may be co-located with components of CU 129.

In a possible virtualized O-RAN implementation, CU 129, 5G core 139, and/or orchestrator 138 can be implemented virtually as software being executed by general-purpose computing equipment, such as in a data center of a cloud-computing platform, as detailed herein. Therefore, depending on needs, the functionality of a CU, and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 100A, cloud-based cellular network components 128 include CU 129, 5G core 139, and orchestrator 138. Such cloud-based cellular network components 128 may be executed as specialized software executed by underlying general-purpose computer servers. Cloud-based cellular network components 128 may be executed on a third-party cloud-based computing platform or a cloud-based computing platform operated by the same entity that operates the RAN. A cloud-based computing platform may have the ability to devote additional hardware resources to cloud-based cellular network components 128 or implement additional instances of such components when requested.

Kubernetes, or some other container orchestration platform, can be used to create and destroy the logical CU or 5G core units and subunits as needed for the cellular network 120 to function properly. Kubernetes allows for container deployment, scaling, and management. As an example, if cellular traffic increases substantially in a region, an additional logical CU or components of a CU may be deployed in a data center near where the traffic is occurring without any new hardware being deployed. (Rather, processing and storage capabilities of the data center would be devoted to the needed functions.) When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers.

The deployment, scaling, and management of such virtualized components can be managed by orchestrator 138. Orchestrator 138 can represent various software processes executed by underlying computer hardware. Orchestrator 138 can monitor cellular network 120 and determine the amount and location at which cellular network functions should be deployed to meet or attempt to meet service level agreements (SLAs) across slices of the cellular network.

Orchestrator 138 can allow for the instantiation of new cloud-based components of cellular network 120. As an example, to instantiate a new core function, orchestrator 138 can perform a pipeline of calling the core function code from a software repository incorporated as part of, or separate from, cellular network 120; pulling corresponding configuration files (e.g., helm charts); creating Kubernetes nodes/pods; loading the related core function containers; configuring the core function; and activating other support functions (e.g., Prometheus, instances/connections to test tools).

A network slice functions as a virtual network operating on cellular network 120. Cellular network 120 is shared with some number of other network slices, such as hundreds or thousands of network slices. Communication bandwidth and computing resources of the underlying physical network can be reserved for individual network slices, thus allowing the individual network slices to reliably meet defined SLA parameters. By controlling the location and amount of computing and communication resources allocated to a network slice, the quality of service (QOS) and quality of experience (QoE) for UE can be varied on different slices. A network slice can be configured to provide sufficient resources for a particular application to be properly executed and delivered (e.g., gaming services, video services, voice services, location services, sensor reporting services, data services, etc.). However, resources are not infinite, so allocation of an excess of resources to a particular UE group and/or application may be desired to be avoided. Further, a cost may be attached to cellular slices: the greater the amount of resources dedicated, the greater the cost to the user; thus, optimization between performance and cost is desirable.

Particular network slices may only be reserved in particular geographic regions. For instance, a first set of network slices may be present at RU 125-1 and DU 127-1, a second set of network slices, which may only partially overlap or may be wholly different from the first set, may be reserved at RU 125-2 and DU 127-2.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

Components such as DUs 127, CU 129, orchestrator 138, and 5G core 139 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing must be performed.

5G core 139, which can be physically distributed across data centers or located at a central national data center (NDC), can perform various core functions of the cellular network. 5G core 139 can include: network resource management components; policy management components; subscriber management components; and packet control components. Individual components may communicate on a bus, thus allowing various components of 5G core 139 to communicate with each other directly. 5G core 139 is simplified to show some key components. Implementations can involve additional other components.

Network resource management components can include network repository function (NRF) and network slice selection function (NSSF) (e.g., NSSF 338). NRF can allow 5G network functions (NFs) to register and discover each other via a standards-based application programming interface (API). NSSF can be used by access and mobility management function (AMF) (e.g., AMF 234) to assist with the selection of a network slice that will serve a particular UE.

Policy management components can include charging function (CHF) and policy control function (PCF) (e.g., PCF 335). CHF allows charging services to be offered to authorized network functions. Converged online and offline charging can be supported. PCF allows for policy control functions and the related 5G signaling interfaces to be supported.

Subscriber management components can include unified data management (UDM) (e.g., UDM 336) and authentication server function (AUSF) (e.g., AUSF 337). UDM can allow for generation of authentication vectors, user identification handling, NF registration management, and retrieval of UE individual subscription data for slice selection. AUSF performs authentication with UE.

Packet control components can include access and mobility management function (AMF) (e.g., AMF 234) and session management function (SMF) (e.g., SMF 333). AMF can receive connection- and session-related information from UE and is responsible for handling connection and mobility management tasks. SMF is responsible for interacting with the decoupled data plane, creating updating and removing protocol data unit (PDU) sessions, and managing session context with the user plane function (UPF) (e.g., manage UE context and network handovers between base stations).

User plane function (UPF) (e.g., UPF 332) can be responsible for packet routing and forwarding, packet inspection, QoS handling, and external PDU sessions for interconnecting with a data network (DN) (e.g., DN 380) (e.g., the Internet) or various access networks. Access networks can include the RAN of cellular network 120.

The SMF 333 may configure or control the UPF 332 via the N4 interface. For example, the SMF 333 may control packet forwarding rules used by the UPF 332 and adjust QoS parameters for QoS enforcement of data flows (e.g., limiting available data rates). In some cases, multiple SMF/UPF pairs may be used to simultaneously manage user plane traffic for a particular user device, such as UE 210. For example, a set of SMFs may be associated with UE 210, where each SMF of the set of SMFs corresponds with a network slice. The SMF 333 may control the UPF 332 on a per end user data session basis, in which the SMF 333 may create, update, and remove session information in the UPF 332.

Decoupling control signaling in the control plane from user plane traffic in the user plane may allow the UPF 332 to be positioned in close proximity to the edge of a network compared with the AMF 234. As a closer geographic or topographic proximity may reduce the electrical distance, the electrical distance from the UPF 332 to the UE 210 may be less than the electrical distance of the AMF 234 to the UE 210.

5G core 139 may reside on a cloud computing platform. While from a client's or user's point of view, the “cloud” can be envisioned as an ephemeral computing workspace that occupies no physical space, in reality, a cloud computing platform is an interconnected group of data centers throughout which computing and storage resources are spread. Therefore, data centers may be scattered geographically and can provide redundancy.

In some embodiments, the cellular network 120 includes an AMF resource manager 150 that implements dynamic scaling of AMF resources in a cellular network. In some embodiments, the AMF resource manager 150 is part of the base station(s). In some embodiments, the AMF resource manager 150 is part of the 5G core 139. Further details regarding the operations of the AMF resource manager 150 are described below with reference to FIGS. 2-7.

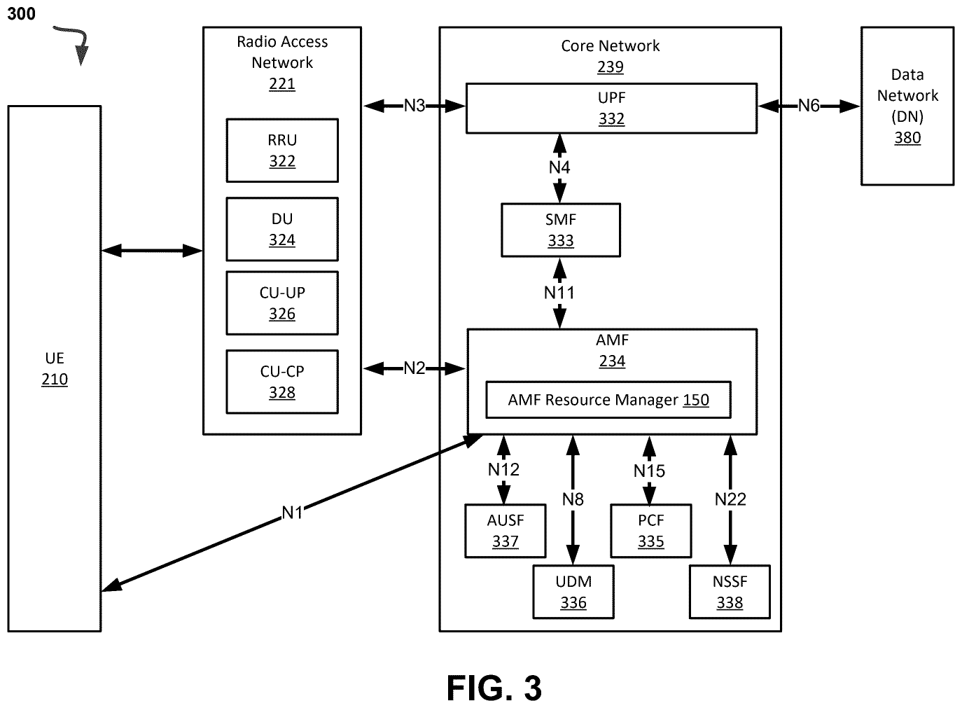

FIG. 2 is a block diagram of example AMF resource managers according to at least one embodiment. Referring to FIG. 2, a 5G network 220 includes a radio access network (RAN) 221 and a core network 239 according to at least one embodiment. In at least one embodiment, an AMF resource manager (e.g., AMF resource manager 150-3) can be implemented in the 5G network 220. In at least one embodiment, an AMF resource manager (e.g., AMF resource manager 150-2) can be implemented in the core network 239. In at least one embodiment, an AMF resource manager (e.g., AMF resource manager 150-1) can be implemented in the AMF 234. In at least one embodiment, each of AMF resource managers 150-1, 150-2, 150-3 can independently perform the operations described herein. In at least one embodiment, a combination of any of AMF resource managers 150-1, 150-2, 150-3 can coordinately perform the operations described herein In at least one embodiment, AMF resource manager 150 described in FIGS. 1 and 3 can be the same to one or more of AMF resource managers 150-1, 150-2, 150-3. FIG. 3 illustrates a block diagram of an example AMF resource manager implements dynamic scaling of AMF resources in a cellular network according to at least one embodiment.

Referring to FIGS. 2 and 3, the 5G network 220 connects user equipment (UE) 210 to the data network (DN) 380, and the DN 380 can include the Internet, a local area network (LAN), a wide area network (WAN), a private data network, a wireless network, a wired network, or a combination of networks. The UE 210 can include an electronic device with wireless connectivity or cellular communication capability, including mobile computing device such as a mobile phone or handheld computing device, and non-mobile computing device. In at least one example, the UE 210 can include a 5G smartphone or a 5G cellular device that connects to the RAN 221 via a wireless connection. The UE 210 can include one of a number of UEs not depicted that are in communication with the RAN 221. The UE 210 may include mobile and non-mobile computing devices. The UE 210 may include laptop computers, desktop computers, an Internet-of-Things (IoT) devices, and/or any other electronic computing device that includes a wireless communications interface to access the RAN 221.

The RAN 221 includes a remote radio unit (RRU) 322 for wirelessly communicating with UE 210. The RRU 322 can include a Radio Unit (RU) and may include one or more radio transceivers for wirelessly communicating with UE 210. The RRU 322 may include circuitry for converting signals sent to and from an antenna of a Base Station into digital signals for transmission over packet networks. The RAN 221 may correspond with a 5G radio Base Station that connects user equipment to the core network 239. The 5G radio Base Station may be referred to as a generation Node B, a “gNodeB,” or a “gNB.” A Base Station may refer to a network element that is responsible for the transmission and reception of radio signals in one or more cells to or from user equipment, such as UE 210. The RAN 221 can include a new-generation radio access network (NG-RAN) that uses the 5G NR interface. In some embodiments, the distributed unit (DU) 324 and the centralized unit (CU) of the RAN 221 may be co-located with the RRU 322. In other embodiments, the DU 324 and the RRU 322 may be co-located at a cell site and the centralized unit (CU) may be located within a local data center (LDC). The DU 324 can include a logical node configured to provide functions for the radio link control (RLC) layer, the medium access control (MAC) layer, and the physical layer (PHY) layers. The centralized unit (CU) can be partitioned into a CU user plane portion (CU-UP) 326 and a CU control plane portion (CU-CP) 328. The CU-CP 328 may perform functions related to a control plane, such as connection setup, mobility, and security. The CU-UP 326 may perform functions related to a user plane, such as user data transmission and reception functions. In one example, the centralized units (CUs) can include a logical node configured to provide functions for the radio resource control (RRC) layer, the packet data convergence control (PDCP) layer, and the service data adaptation protocol (SDAP) layer. The centralized unit for the control plane (CU-CP) 328 can include a logical node configured to provide functions of the control plane part of the RRC and PDCP. The centralized unit for the user plane (CU-UP) 326 can include a logical node configured to provide functions of the user plane part of the SDAP and PDCP. In some embodiments, the RAN 221 may include virtualized CU units and virtualized DU units. The virtualized DU units can include virtualized versions of distributed units (DUs). The virtualized CU units can include virtualized versions of centralized units (CUs). Virtualizing the control plane and user plane functions allows the centralized units (CUs) to be consolidated in one or more data centers on RAN-based open interfaces.

In some embodiments, the RAN 221 may include a set of one or more remote radio units (RRUs) that includes radio transceivers (or combinations of radio transmitters and receivers) for wirelessly communicating with UEs. The set of RRUs may correspond with a network of cells (or coverage areas) that provide continuous or nearly continuous overlapping service to UEs, such as UE 210, over a geographic area. Some cells may correspond with stationary coverage areas and other cells may correspond with coverage areas that change over time (e.g., due to movement of a mobile RRU).

In some cases, the UE 210 may be capable of transmitting signals to and receiving signals from one or more RRUs within the network of cells over time. One or more cells may correspond with a cell site. The cells within the network of cells may be configured to facilitate communication between UE 210 and other UEs and/or between UE 210 and a data network. The cells may include macrocells (e.g., capable of reaching 18 miles) and small cells, such as microcells (e.g., capable of reaching 1.2 miles), picocells (e.g., capable of reaching 0.12 miles), and femtocells (e.g., capable of reaching 32 feet). Small cells may communicate through macrocells. Although the range of small cells may be limited, small cells may enable mm Wave frequencies with high-speed connectivity to UEs within a short distance of the small cells. Macrocells may transit and receive radio signals using multiple-input multiple-output (MIMO) antennas that may be connected to a cell tower, an antenna mast, or a raised structure.

The core network 239 may utilize a cloud-native service-based architecture (SBA) in which different core network functions (e.g., authentication, security, session management, and core access and mobility functions) are virtualized and implemented as loosely coupled independent services that communicate with each other, for example, using hypertext transfer protocol (HTTP) protocols and APIs. In some cases, control plane (CP) functions may interact with each other using the service-based architecture. In at least one embodiment, a microservices-based architecture in which software is composed of small independent services that communicate over well-defined APIs may be used for implementing some of the core network functions. For example, control plane (CP) network functions for performing session management may be implemented as containerized applications or microservices. Although a microservice-based architecture does not necessarily require a container-based implementation, a container-based implementation may offer improved scalability and availability over other approaches. Network functions that have been implemented using microservices may store their state information using the unstructured data storage function (UDSF) that supports data storage for stateless network functions across the service-based architecture (SBA).

The core network 239 may include a set of network elements that are configured to offer various data and telecommunications services to subscribers or end users of user equipment, such as UE 210. Examples of network elements include network computers, network processors, networking hardware, networking equipment, routers, switches, hubs, bridges, radio network controllers, gateways, servers, virtualized network functions, and network functions virtualization infrastructure. A network element can include a real or virtualized component that provides wired or wireless communication network services.

The primary core network functions can include the access and mobility management function (AMF) 234, the session management function (SMF) 333, and the user plane function (UPF) 332. The AMF 234 may act as a single-entry point for a UE connection and perform mobility management, registration management, and connection management between DN 380 and UE 210. The AMF may interface with UE 210 and act as a single-entry point for a UE connection. The AMF 234 may interface with the SMF 333 to track user sessions. The AMF 234 may interface with a network slice selection function (NSSF) 338 to select network slice instances for user equipment. When user equipment is leaving a first coverage area and entering a second coverage area, the AMF 234 may be responsible for coordinating the handoff between the coverage areas whether the coverage areas are associated with the same radio access network or different radio access networks. The SMF 333 may perform session management, user plane selection, and Internet Protocol (IP) address allocation. The UPF 332 may perform packet processing including routing and forwarding, quality of service (QOS) handling, and packet data unit (PDU) session management. The UPF 332 may serve as an ingress and egress point for user plane traffic and provide anchored mobility support for user equipment. The UPF 332 may be implemented as a software process or application running within a virtualized infrastructure or a cloud-based compute and storage infrastructure.

The UPF 332 may transfer downlink data received from the data network to user equipment, via the RAN 221 and/or transfer uplink data received from user equipment to the data network via the RAN 221. An uplink can include a radio link though which user equipment transmits data and/or control signals to the RAN 221. A downlink can include a radio link through which the RAN 221 transmits data and/or control signals to the user equipment.

Uplink packets arriving from the RAN 221 may use a general packet radio service (GPRS) tunneling protocol (or GTP) to reach the UPF 332. The GPRS tunneling protocol for the user plane may support multiplexing of traffic from different PDU sessions by tunneling user data over the interface N3 between the RAN 221 and the UPF 332. The UPF 332 may remove the packet headers belonging to the GTP tunnel before forwarding the user plane packets towards the data network. As the UPF 332 may provide connectivity towards other data networks in addition to the data network, the UPF 332 must ensure that the user plane packets are forwarded towards the correct data network. Each GTP tunnel may belong to a specific PDU session. Each PDU session may be set up towards a specific data network name (DNN) that uniquely identifies the data network to which the user plane packets should be forwarded. The UPF 332 may keep a record of the mapping between the GTP tunnel, the PDU session, and the DNN for the data network to which the user plane packets are directed.

Downlink packets arriving from the data network are mapped onto a specific QoS flow belonging to a specific PDU session before forwarded towards the appropriate RAN 221. A QoS flow may correspond with a stream of data packets that have equal quality of service (QOS). The PDU session may utilize one or more quality of service (QOS) flows to exchange traffic (e.g., data and voice traffic) between the UE 210 and the DN 380. The one or more QoS flows can include the finest granularity of QoS differentiation within the PDU session. The PDU session may belong to a network slice instance through the 5G network 220. To establish user plane connectivity from the UE 210 to the DN 380, the AMF 234 that supports the network slice instance may be selected and a PDU session via the network slice instance may be established. In some cases, the PDU session may be of type IPv4 or IPv6 for transporting IP packets. The RAN 221 may be configured to establish and release parts of the PDU session that cross the radio interface.

Other core network functions may include a network repository function (NRF) for maintaining a list of available network functions and providing network function service registration and discovery, a policy control function (PCF) 335 for enforcing policy rules for control plane functions, an authentication server function (AUSF) 337 for authenticating user equipment and handling authentication related functionality, a network slice selection function (NSSF) 338 for selecting network slice instances, and an application function (AF) (not shown) for providing application services. Application-level session information may be exchanged between the AF and PCF 335 (e.g., bandwidth requirements for QoS). In some cases, when user equipment requests access to resources, such as establishing a PDU session or a QoS flow, the PCF 335 may dynamically decide if the user equipment should grant the requested access based on a location of the user equipment.

The 5G network 220 may provide one or more network slices, where each network slice may include a set of network functions that are selected to provide specific telecommunications services. For example, each network slice can include a configuration of network functions, network applications, and underlying cloud-based compute and storage infrastructure. In some cases, a network slice may correspond with a logical instantiation of a 5G network, such as an instantiation of the 5G network 220. In some cases, the 5G network 220 may support customized policy configuration and enforcement between network slices per service level agreements (SLAs) within the RAN 221. User equipment, such as UE 210, may connect to multiple network slices at the same time (e.g., eight different network slices). In some cases, the 5G network 220 may dynamically generate network slices to provide telecommunications services for various use cases, such the enhanced Mobile Broadband (eMBB), Ultra-Reliable and Low-Latency Communication (URLCC), and massive Machine Type Communication (mMTC) use cases.

As depicted, AMF 234 may be connected to SMF 333, PCF 335, UDM 336, AUSF 337, and NSSF 338 via different interfaces. AMF 234 may be connected to SMF 333 via an N11 interface. AMF 234 may be connected to PCF 335 via an N15 interface. AMF 234 may be connected to UDM 336 via an N8 interface. AMF 234 may be connected to AUSF 337 via an N12 interface. AMF 234 may be connected to NSSF 338 via an N22 interface.

The RAN 221 may be connected to the AMF 234, which may allocate temporary unique identifiers, determine tracking areas, and select appropriate policy control functions (PCFs) for user equipment, via an N2 interface. The N2 interface may be used for transferring control plane signaling between the RAN 221 and the AMF 234. The N3 Interface may be used for transferring user data (e.g., user plane traffic) from the RAN 221 to the UPF 332 and may be used for providing low-latency services using edge computing resources. The electrical distance from the UPF 332 (e.g., located at the edge of a network) to user equipment, such as UE 210, may impact the latency and performance services provided to the user equipment. The data may be tunneled across the N3 Interface (e.g., IP routing may be done on the tunnel header IP address instead of using end user IP addresses). This may allow for maintaining a stable IP anchor point even though UE 210 may be moving around a network of cells or moving from one coverage area into another coverage area. The UE 210 may be connected to the SMF 333 via an N1 interface, which may transfer UE information directly to the AMF 234 and an N11 interface. The UPF 332 may be connected to the data network 380 via an N6 interface. The N6 interface may be used for providing connectivity between the UPF 332 and other external or internal data networks (e.g., to the Internet). The data may not be tunneled across the N6 interface as IP packets may be routed based on end user IP addresses. The UPF 332 may connect to the SMF 333 via the N4 interface. The RAN 221 may be connected to the SMF 333, via the N2 interface and the N11 interface. In addition, although not shown in FIG. 3, AMF 234 may be connected to evolved packet data gateway (ePDG), where ePDG can be connected through non-3Gpp based access network (e.g., untrusted WLANs) to UE 210, and therefore the interface includes multiple network connections.

A cloud-based compute and storage infrastructure can include a networked computing environment that provides a cloud computing environment. Cloud computing may refer to Internet-based computing, where shared resources, software, and/or information may be provided to one or more computing devices on-demand via the Internet (or other network). The term “cloud” may be used as a metaphor for the Internet, based on the cloud drawings used in computer networking diagrams to depict the Internet as an abstraction of the underlying infrastructure it represents.

Virtualization allows virtual hardware to be created and decoupled from the underlying physical hardware. One example of a virtualized component is a virtual router (or a vRouter). Another example of a virtualized component is a virtual machine. A virtual machine can include a software implementation of a physical machine. The virtual machine may include one or more virtual hardware devices, such as a virtual processor, a virtual memory, a virtual disk, or a virtual network interface card. The virtual machine may load and execute an operating system and applications from the virtual memory. The operating system and applications used by the virtual machine may be stored using the virtual disk. The virtual machine may be stored as a set of files including a virtual disk file for storing the contents of a virtual disk and a virtual machine configuration file for storing configuration settings for the virtual machine. The configuration settings may include the number of virtual processors (e.g., four virtual CPUs), the size of a virtual memory, and the size of a virtual disk (e.g., a 64 GB virtual disk) for the virtual machine. Another example of a virtualized component is a software container or an application container that encapsulates an application's environment. In some embodiments, applications and services may be run using virtual machines instead of containers in order to improve security. A common virtual machine may also be used to run applications and/or containers for a number of closely related network services.

The 5G network 220 may implement various network functions, such as the core network functions and radio access network functions, using a cloud-based compute and storage infrastructure. A network function may be implemented as a software instance running on hardware or as a virtualized network function. Virtual network functions (VNFs) can include implementations of network functions as software processes or applications. In at least one example, a virtual network function (VNF) may be implemented as a software process or application that is run using virtual machines (VMs) or application containers within the cloud-based compute and storage infrastructure. Application containers (or containers) allow applications to be bundled with their own libraries and configuration files, and then executed in isolation on a single operating system (OS) kernel. Application containerization may refer to an OS-level virtualization method that allows isolated applications to be run on a single host and access the same OS kernel. Containers may run on bare-metal systems, cloud instances, and virtual machines. Network functions virtualization may be used to virtualize network functions, for example, via virtual machines, containers, and/or virtual hardware that runs processor readable code or executable instructions stored in one or more computer-readable storage mediums (e.g., one or more data storage devices).

The AMF resource manager 150 may monitor parameters associated with the AMF 234 in the 5G network 220. These parameters are associated with a demand on performance of the AMF, and may include parameters characterizing: time points or periods, geographic regions associated with data center including the AMF, the number of UEs served by the AMF, the state of each UE, data demand, the number of base stations served by AMF, the capacity and status of each base station, traffic in various interfaces to AMF, etc.

The time points or periods may indicate the time (e.g., workday day time) or period of time (e.g., shopping season, sports season). The data center may include national data center (NDC), regional data center (RDC), and edge data centers (BEDC), and the design of data centers may be based on latency requirements and data processing considerations. The geographic regions associated with data center including the AMF may indicate the expected demand for certain resources provided by the AMF.

The number of UEs may include the number of subscribers served by the AMF. The number of user equipment (UE) may include a (e.g., real-time) count of UE connected to the base stations provided by the AMF. The data demand may include a prediction of data size at a specific time point, for example, based on historical data. The data demand may be based on type of services, such as static or dynamic, that AMF is handling.

The state of UE may include movement of mobile UE. The state of UE may include the transaction mode of UE (e.g., idle mode or connected mode). The idle mode means that UE does not have a request to send or receive data to or from the base station or have the communication with the base station taking place. The connected mode means that UE has a request to send or receive data to or from the base station or has the communication with the base station taking place. The state of UE may include the proximity (e.g., measured by distance) to the base station.

The base station (e.g., “gNodeB” or “gNB”) refers to a network element responsible for the transmission and reception of radio signals in one or more cells (or coverage areas) to or from user equipment (UE). The base station may include CUs, DUs, and RUs. The number of base stations served by AMF may include the number of CUs served by the AMF, the number of DUs served by each CU, the number of cells each DU handles, etc.

The capacity and status of each base station may include a CU capacity, a DU capacity, current utilization including resource availability, user throughput, bearer service parameters, etc. The user throughput is the number of correctly received bits by users delivered to upper layers over a certain period of time, divided by the channel bandwidth (e.g., measured in bits/s/Hz). Bearer Service is a service that allows transmission of information signals between network interfaces and gives the subscriber the capacity required to transmit appropriate signals between certain access points, i.e., user network interfaces. The parameters of bearer services include rate adapted sub-rate information like circuit switched asynchronous and synchronous duplex data (e.g., measured in bits), speech and data swapping during a call (e.g., selection of 3.1 kHz audio service).

The traffic in various interfaces to AMF may include traffic in interface N12 to AUSF, traffic in interface N8 to UDM, interface N11 to SMF, traffic in interface N15 to PCF, traffic in interface N2 to RAN (e.g., base stations), traffic in evolved packet data gateway (ePDG) connected through non-3Gpp based access network (e.g., untrusted WLANs) to UE, etc. The traffic in various interfaces to AMF may further include traffic in interface N22 to NSSF, traffic in interface N1 to UE, etc.

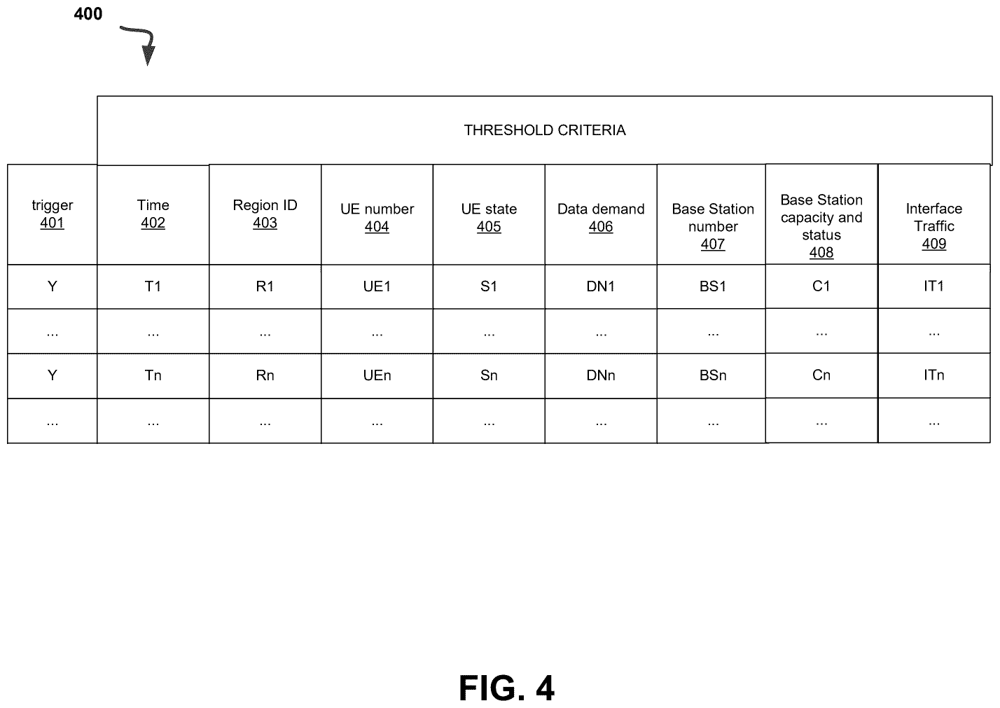

The AMF resource manager 150 may determine whether the monitored parameters satisfy a threshold criterion for triggering an adjustment of resources used in AMF. For example, the AMF resource manager 150 may determine that when a specific parameter described above (e.g., the number of UE) of the signal reaches or exceeds a threshold value, the monitored parameters satisfy the threshold criterion. As another example, the AMF resource manager 150 may determine that when each of several parameters described above (e.g., the number of UE, traffic in a certain interface, etc.) of the signal reaches or exceeds a threshold value, the monitored parameters satisfy the threshold criterion. FIG. 4 provides examples threshold criteria.

Referring to FIG. 4, the threshold criterion may consider one or more of: time 402, region ID 403, UE number 404, UE state 405, data demand 406, base station number 407, base station capacity and status 408, or interface traffic 409. The AMF resource manager 150 may compare the real-time measurement of the specific parameter to the threshold value or threshold range (e.g., value or range provided in the threshold criterion table 400) of the specific parameter to determine whether to trigger 401 to adjust the AMF resources. For example, time 402 may represent a time point (e.g., every Monday 9 am, 12 am on the day of a holiday) or a time period (e.g., weekday 9 am to 5 pm, super bowl live time, holiday season), and the AMF resource manager 150 may compare the measured time to the threshold value T1, and when the measured time reaches T1, the AMF resource manager 150 determines that the threshold criterion is satisfied to trigger the adjustment of AMF resources. Region ID 403 may represent a geographic region associated with a data center, such as a specific region covered by a data center (NDC), regional data center (RDC), or edge data centers (BEDC), and the AMF resource manager 150 may compare the measured region ID to the threshold value R1, and when the measured region ID matches R1, the AMF resource manager 150 determines that the threshold criterion is satisfied to trigger the adjustment of AMF resources.

UE number 404 may represent a number of a plurality of user equipment (UE) served by the AMF, and the AMF resource manager 150 may compare the measured UE number to the threshold value UE1, and when the measured UE number exceeds UE1, the AMF resource manager 150 determines that the threshold criterion is satisfied to trigger the adjustment of AMF resources. UE state 405 may represent a state of each UE of the plurality of UE, and the state may include one or more of: movement of mobile UE, the transaction mode of UE (e.g., idle mode or connected mode), or the proximity (e.g., measured by distance) to the base station, and the AMF resource manager 150 may compare the measured UE state to the threshold value S1, and when the measured UE state exceeds S1, the AMF resource manager 150 determines that the threshold criterion is satisfied to trigger the adjustment of AMF resources. Data demand 406 may represent a prediction of data size at a specific time point, based on historical data or type of services, and the AMF resource manager 150 may compare the measured data demand to the threshold value DN1, and when the measured data demand exceeds DN1, the AMF resource manager 150 determines that the threshold criterion is satisfied to trigger the adjustment of AMF resources.

Base station number 407 may represent a number of a plurality of base stations served by AMF and include one or more of: the number of CUs served by the AMF, the number of DUs served by each CU, the number of cells each DU handles, etc., and the AMF resource manager 150 may compare the measured base station number to the threshold value BS1, and when the measured base station number exceeds BS1, the AMF resource manager 150 determines that the threshold criterion is satisfied to trigger the adjustment of AMF resources. Base station capacity and status 408 may represent a capacity and status of each base station of the plurality of base station and include one or more of: a CU capacity, a DU capacity, current utilization including resource availability, user throughput, bearer service parameters), etc., and the AMF resource manager 150 may compare the measured base station capacity and status to the threshold value C1, and when the measured base station capacity and status exceeds C1, the AMF resource manager 150 determines that the threshold criterion is satisfied to trigger the adjustment of AMF resources.

Interface traffic 409 may represent traffic in an interface to the AMF and the interface may include one or more of: interface N12 to AUSF, interface N8 to UDM, interface N11 to SMF, interface N15 to PCF, interface N2 to RAN (e.g., base stations), evolved packet data gateway (ePDG) connected through non-3Gpp based access network (e.g., untrusted WLANs) to UE, etc., and the AMF resource manager 150 may compare the measured traffic to the threshold value IT1, and when the measured traffic exceeds IT1, the AMF resource manager 150 determines that the threshold criterion is satisfied to trigger the adjustment of AMF resources.

Although the threshold criterion described above uses threshold value as examples, the threshold range is also applicable. The threshold criterion may be satisfied using any of the combination of the scenario described above with respect to time 402, region ID 403, UE number 404, UE state 405, data demand 406, base station number 407, base station capacity and status 408, or interface traffic 409. For example, the AMF resource manager 150 may compare the measured UE number to the threshold value UEn and compare the measured base station capacity and status to the threshold value Cn, and when the measured UE number exceeds UEn and the measured base station capacity and status exceeds Cn, the AMF resource manager 150 determines that the threshold criterion is satisfied to trigger the adjustment of AMF resources (e.g., scaling up). Further, although “exceed” “reach” or “match” used in the threshold criterion is described above as examples, the case of “not exceed” “not reach” or “not match” is also applicable. For example, the AMF resource manager 150 may compare the measured UE number to the threshold value UEn and compare the measured base station capacity and status to the threshold value Cn, and when the measured UE number does not exceed UEn and the measured base station capacity and status does not exceed Cn, the AMF resource manager 150 determines that the threshold criterion is satisfied to trigger the adjustment of AMF resources (e.g., scaling down).

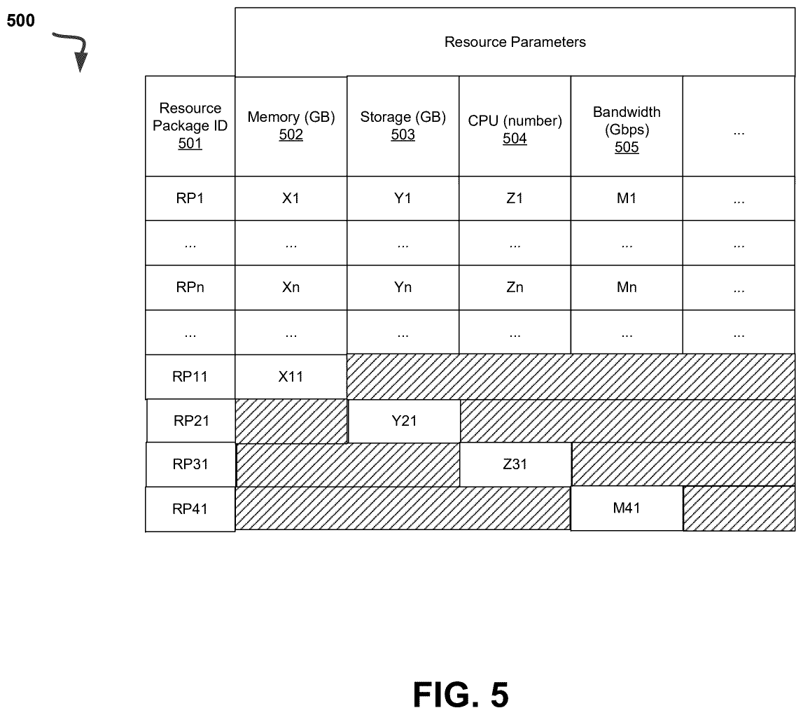

The AMF resource manager 150 may dynamically determine, based on the monitored parameters, a value of a resource parameter of the AMF. In some implementations, the AMF resource manager 150 may determine the value of the resource parameter of the AMF responsive to determining that the monitored parameters satisfy a threshold criterion. In some implementations, the resource parameter of the AMF comprises at least one of: a capacity of memory, a capacity of storage, the number of CPU, the bandwidth of network interconnection, provided locally (e.g., physically) or in the cloud (e.g., in virtualization). In some implementations, the AMF resource manager 150 may dynamically, based on the monitored parameters, generate a value higher than a preset value of a resource parameter of the AMF. In some implementations, the AMF resource manager 150 may dynamically, based on the monitored parameters, generate a value lower than a preset value of a resource parameter of the AMF. The AMF resource manager 150 may generate, based on the monitored parameters, a value of a resource parameter of the AMF according to algorithm. FIG. 5 provides examples resource parameters. In some implementations, the AMF resource manager 150 may determine, based on the monitored parameters, a value of a resource parameter of the AMF by incrementally increasing or decreasing the value of the resource parameter of the AMF that is currently in use (e.g., a pre-defined incremental value of the resource parameter). In some implementations, the AMF resource manager 150 may determine, based on the monitored parameters, a value of a resource parameter of the AMF by selecting the value from a set of pre-configured values (e.g., pre-configured values of each resource parameter stored in a data structure). FIG. 5 provides examples resource parameters.

Referring to FIG. 5, the AMF resource manager 150 may generate, based on the monitored parameters, one or more of: a value of memory capacity 502, a value of storage capacity 503, a value of CPU number 504, or a value of bandwidth 505. In some implementations, the AMF resource manager 150 may determine whether the determined value of the memory capacity 502 falls in the range X11, and responsive to determining that the determined value of the memory capacity 502 falls in the range, the AMF resource manager 150 may retrieve a resource package ID (e.g., RP 11), which may represent a resource package including only the memory resource and can be sent to a resource provider for receiving such resource package. In some implementations, the AMF resource manager 150 may determine whether the determined value of the storage capacity 503 falls in the range Y21, and responsive to determining that the determined value of the storage capacity 503 falls in the range, the AMF resource manager 150 may retrieve a resource package ID (e.g., RP 21), which may represent a resource package including only the storage resource and can be sent to a resource provider for receiving such resource package. In some implementations, the AMF resource manager 150 may determine whether the determined value of the CPU number 504 falls in the range Z31, and responsive to determining that the determined value of the CPU number 504 falls in the range, the AMF resource manager 150 may retrieve a resource package ID (e.g., RP 31), which may represent a resource package including only the CPU resource and can be sent to a resource provider for receiving such resource package. In some implementations, the AMF resource manager 150 may determine whether the determined value of the bandwidth 505 falls in the range M41, and responsive to determining that the determined value of the bandwidth 505 falls in the range, the AMF resource manager 150 may retrieve a resource package ID (e.g., RP 41), which may represent a resource package including only the bandwidth resource and can be sent to a resource provider for receiving such resource package.

In some implementations, the AMF resource manager 150 may determine whether one or more determined values of the resource parameters fall in the respective range provided in a resource package (e.g., the determined value of the memory capacity 502 falls in the range X1, the determined value of the storage capacity 503 falls in the range Y1, the determined value of the CPU number 504 falls in the range Z1, or the determined value of the bandwidth 505 falls in the range M1), and responsive to determining that one or more determined values of the resource parameters falls in the respective range, the AMF resource manager 150 may retrieve a resource package ID (e.g., RP 1), which can be sent to a resource provider for receiving such resource package. In some cases, the resource package ID may be vendor specific.

In some implementations, the AMF resource manager 150 may consider the determined values of the resource parameters in combination to determine whether to retrieve a new resource package ID or determine the new resource package ID to retrieve. For example, the AMF resource manager 150 may determine the determined value of the memory capacity 502 falls in the range X1 and determine the determined value of the storage capacity 503 falls in the range Yn, and the AMF resource manager 150 may determine either RPI or RPn as the new resource package ID to be send to a resource provider for receiving such resource package.

In some implementations, the AMF resource manager 150 may predict, based on the monitored parameters, a reference value of the resource parameter for dynamic determination of the value used to scale up or scale down of resources. In some implementations, the AMF resource manager 150 may retrieve historical data and use the historical data to predict a reference value of the resource parameter. In some implementations, the historical data may be specific to a resource parameter. In some implementations, the historical data may consider various resource parameters in combination. In some implementations, the AMF resource manager 150 may predict, based on the monitored parameters, a maximum value of the resource parameter to be used such that the AMF resource manager 150 will not request resources beyond the limit. In some implementations, the AMF resource manager 150 may predict, based on the monitored parameters, a minimum value of the resource parameter to be used such that the AMF resource manager 150 will not request resources that would affect the basic operation.

In some implementations, the reference value is weighted to be used with the monitored parameters to determine the value of the resource parameter of the AMF. For example, the reference value is a maximum or minimum value of a resource parameter, and the maximum or minimum value of a resource parameter is weighted and used with the monitored parameters to determine the value of the resource parameter of the AMF.

The AMF resource manager 150 may adjust resources of the AMF according to the value of the resource parameter. In some implementations, the AMF resource manager 150 may configure the AMF using the determined value higher than a default value of resource parameter of the AMF. In some implementations, the AMF resource manager 150 may configure the AMF using the determined value lower than a default value of resource parameter of the AMF. In some implementations, the AMF resource manager 150 may retrieve the resource package described above and adjust one or more resources of the AMF by using the retrieved resource package.

In some implementations, a system (e.g., system 100 in FIG. 1, or system 200 in FIG. 2) may include a computing system to facilitate a cellular network (e.g., the cellular network 120 in FIG. 1, or 5G network in FIG. 2), the computing system may include one or more processing devices and memory communicatively coupled with and readable by the one or more processing devices and having stored therein processor-readable instructions which, when executed by the one or more processing devices, cause the one or more processing devices to perform operations described herein.

The computing system may be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The processing device may represent one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device may also be one or more special-purpose processing devices such as an application specific integrated circuit (ASIC), a field programmable gate array (FPGA), a digital signal processor (DSP), network processor, or the like. Processing device may be configured to execute processor-readable instructions for performing the operations and steps discussed herein.

The memory may represent any combination of the different types of non-volatile memory devices (e.g., not- and (NAND) type flash memory and write-in-place memory, such as a three-dimensional cross-point (“3D cross-point”) memory device) and/or volatile memory devices (e.g., random access memory (RAM), such as dynamic random access memory (DRAM) and synchronous dynamic random access memory (SDRAM)). Examples of memory include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory further include a dual in-line memory module (DIMM), a small outline DIMM (SO-DIMM), and various types of non-volatile dual in-line memory modules (NVDIMMs).

In some implementations, a system (e.g., system 100 in FIG. 1, or system 200 in FIG. 2) may include one or more non-transitory, computer-readable storage media having computer-readable instructions thereon which, when executed by one or more processing devices, cause the one or more processing devices to perform operations described herein. The term “computer-readable storage medium” should be taken to include a single medium or multiple media that store the one or more sets of instructions. The term “computer-readable storage medium” shall also be taken to include any medium that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media. Processor-readable instructions or computer-readable instructions may include instructions to implement functionality corresponding to an AMF resource manager (e.g., the AMF resource manager 150 of FIGS. 1-3).

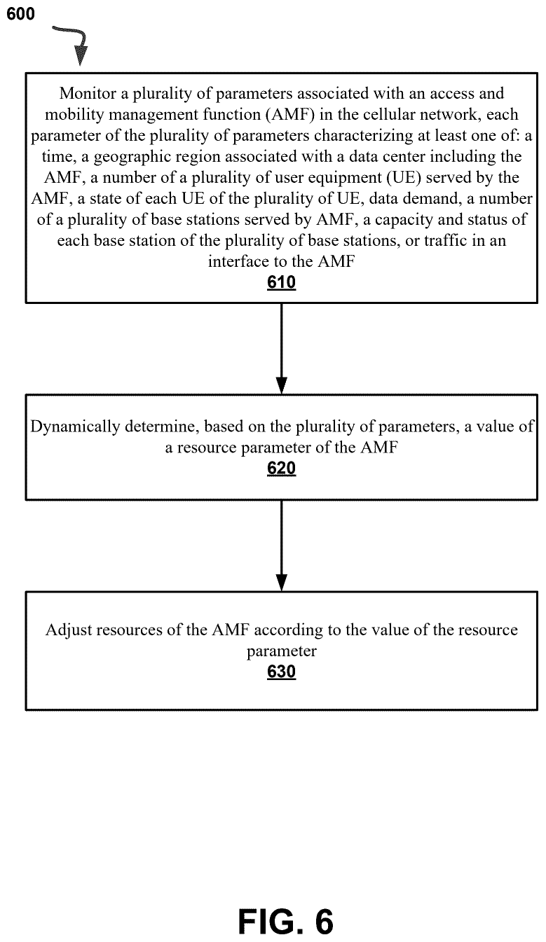

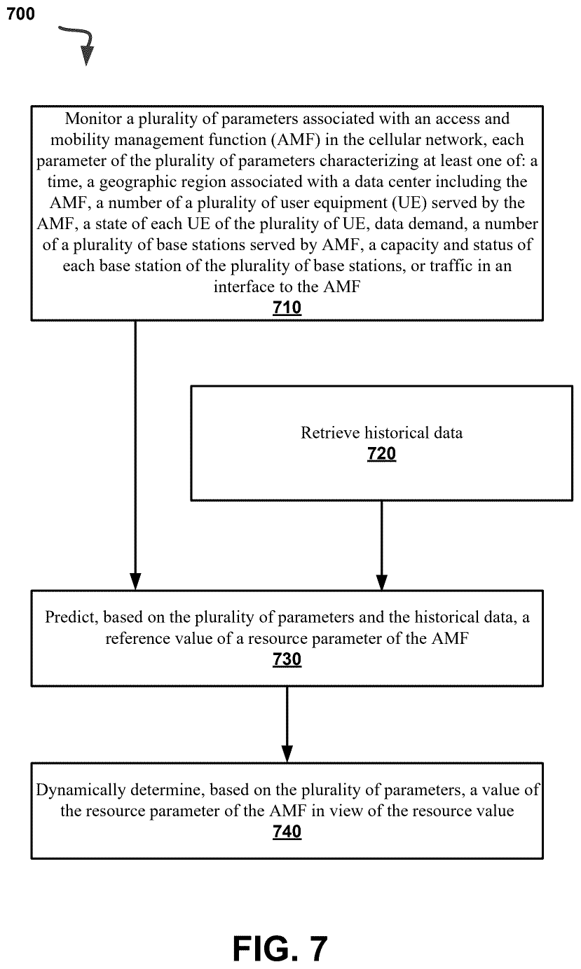

FIGS. 6 and 7 are flow diagrams of methods 600 and 700 of dynamic scaling of access and mobility management function (AMF) resources in a cellular network according to at least one embodiment. The methods 600 and 700 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the methods 600 and 700 are performed by the system 100 of FIG. 1. In one embodiment, the methods 600 and 700 are performed by the AMF resource manager 150 of FIGS. 1-3.

Referring to FIG. 6, at operation 610, the processing logic may monitor one or more parameters associated with a AMF in the cellular network, each parameter characterizing at least one of: a time, a geographic region associated with a data center including the AMF, a number of a plurality of user equipment (UE) served by the AMF, a state of each UE of the plurality of UE, data demand, a number of a plurality of base stations served by AMF, a capacity and status of each base station of the plurality of base stations, or traffic in an interface to the AMF.

In some implementations, the state of UE comprises at least one of: movement of mobile UE, transaction mode of UE, or proximity to the base station. In some implementations, the number of the plurality of base stations comprises at least one of: a number of centralized units served by the AMF, a number of distributed units served by each centralized unit, or a number of cells each distributed unit handles. In some implementations, the capacity and status of the base station comprises at least one of: a centralized unit capacity, a distributed unit capacity, current utilization including resource availability, a user throughput, or a bearer service parameter. In some implementations, the traffic in the interface to the AMF comprises at least one of: a traffic in an interface N12 to authentication server function (AUSF), a traffic in an interface N8 to unified data management (UDM), a traffic in an interface N11 to session management function (SMF), a traffic in an interface N15 to policy control function (PCF), a traffic in an interface N2 to the base stations, or a traffic in an evolved packet data gateway (ePDG).

At operation 620, the processing logic may dynamically determine, based on the monitored parameters, a value of a resource parameter of AMF of the cellular network. In some implementations, the resource parameter comprises at least one of: a capacity of memory, a capacity of storage, a number of CPU, or a bandwidth of network interconnection. In some implementations, the processing logic may determine whether one or more of the monitored parameters satisfy one or more threshold criteria, wherein dynamically determining the value of the resource parameter of the AMF is performed responsive to determining that one or more of the monitored parameters satisfy one or more threshold criteria.

In some implementations, the processing logic may predict a reference value of the resource parameter of the AMF based on historical data. In some implementations, the reference value is weighted to be used with the plurality of parameters to determine the value of the resource parameter of the AMF. In some implementations, the processing logic may incrementally increase or decrease the currently-used value of the resource parameter of the AMF. In some implementations, the processing logic may select the value from a set of pre-configured values.

At operation 630, the processing logic may adjust resources of the AMF according to the value of the resource parameter. In some implementations, the processing logic may configure the resources of the AMF using the determined value. In some implementations, the determined value is higher than a currently-used value of the resource parameter of the AMF. In some implementations, the determined value is lower than a currently-used value of the resource parameter of the AMF.

Referring to FIG. 7, at operation 710, the processing logic may monitor one or more parameters associated with a AMF in the cellular network, each parameter characterizing at least one of: a time, a geographic region associated with a data center including the AMF, a number of a plurality of user equipment (UE) served by the AMF, a state of each UE of the plurality of UE, data demand, a number of a plurality of base stations served by AMF, a capacity and status of each base station of the plurality of base stations, or traffic in an interface to the AMF, which may be similar to or same as the operation 610.

At operation 720, the processing logic may retrieve historical data. In some implementations, the historical data may be specific to a resource parameter. In some implementations, the historical data may be associated with a plurality of resource parameters. At operation 730, the processing logic may predict, based on the plurality of parameters and the historical data, a reference value of a resource parameter of the AMF. In some implementations, the processing logic may predict the reference value according to algorithm.

At operation 740, the processing logic may dynamically determine, based on the monitored parameters, a value of a resource parameter of AMF of the cellular network in view of the reference value. In some implementations, the reference value is weighted to be used with the monitored parameters to determine the value of the resource parameter of the AMF. In some implementations, the reference value comprises a maximum value of the resource parameter, or a minimum value of the resource parameter. The processing logic may then adjust resources of the AMF according to the value of the resource parameter, which may be similar to or same as the operation 630.

In the above description, numerous details are set forth. It will be apparent, however, to one of ordinary skill in the art having the benefit of this disclosure, that embodiments may be practiced without these specific details. In some instances, well-known structures and devices are shown in block diagram form rather than in detail in order to avoid obscuring the description.

Some portions of the detailed description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is used herein and is generally conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “sending,” “receiving,” “scheduling,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, Read-Only Memories (ROMs), compact disc ROMs (CD-ROMs), and magnetic-optical disks, Random Access Memories (RAMs), EPROMs, EEPROMs, magnetic or optical cards, or any type of media suitable for storing electronic instructions. One or more non-transitory, computer-readable storage media can have computer-readable instructions stored thereon which, when executed by one or more processing devices, cause the one or more processing devices to perform the operations described herein.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the present embodiments as described herein. It should also be noted that the terms “when” or the phrase “in response to,” as used herein, should be understood to indicate that there may be intervening time, intervening events, or both before the identified operation is performed.

It is to be understood that the above description is intended to be illustrative, and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

What is claimed is:

1. A method of dynamic scaling of access and mobility management function (AMF) resources in a cellular network, the method comprising:
monitoring a plurality of parameters associated with an access and mobility management function (AMF) in the cellular network, the plurality of parameters being associated with a demand on performance of the AMF;
dynamically determining, based on the plurality of parameters, a value of a resource parameter of the AMF; and
adjusting one or more resources of the AMF according to the value of the resource parameter.

2. The method of claim 1, wherein each parameter of the plurality of parameters characterizes at least one of: a time, a geographic region associated with a data center including the AMF, a number of a plurality of user equipment (UE) served by the AMF, a state of each UE of the plurality of UE, data demand, a number of a plurality of base stations served by AMF, a capacity and status of each base station of the plurality of base stations, or traffic in an interface to the AMF.

3. The method of claim 1, wherein one parameter of the plurality of parameters characterizes a state of each user equipment (UE) of a plurality of UE served by the AMF, and wherein the state of UE comprises at least one of: movement of mobile UE, transaction mode of UE, or proximity to the base station.

4. The method of claim 1, wherein one parameter of the plurality of parameters characterizes a number of a plurality base stations of served by the AMF, and wherein the number of the plurality of base stations comprises at least one of: a number of centralized units served by the AMF, a number of distributed units served by each centralized unit, or a number of cells each distributed unit handles.

5. The method of claim 1, wherein one parameter of the plurality of parameters characterizes a capacity and status of each base station of a plurality of base stations, and wherein the capacity and status of the base station comprises at least one of: a centralized unit capacity, a distributed unit capacity, current utilization including resource availability, a user throughput, or a bearer service parameter.

6. The method of claim 1, wherein one parameter of the plurality of parameters characterizes traffic in an interface to the AMF, and wherein the traffic in the interface to the AMF comprises at least one of: a traffic in an interface N12 to authentication server function (AUSF), a traffic in an interface N8 to unified data management (UDM), a traffic in an interface N11 to session management function (SMF), a traffic in an interface N15 to policy control function (PCF), a traffic in an interface N2 to the base stations, or a traffic in an evolved packet data gateway (ePDG).

7. The method of claim 1, wherein the resource parameter comprises at least one of: a capacity of memory, a capacity of storage, a number of CPU, or a bandwidth of network interconnection.

8. The method of claim 1, further comprising:
determining whether the plurality of parameters satisfies a threshold criterion, wherein dynamically determining the value of the resource parameter of the AMF is performed responsive to determining that the plurality of parameters satisfies the threshold criterion.

9. The method of claim 1, wherein dynamically determining the value of the resource parameter of the AMF comprises:
predicting a reference value of the resource parameter of the AMF based on historical data, wherein the reference value is weighted to be used with the plurality of parameters to determine the value of the resource parameter of the AMF.

10. The method of claim 1, wherein dynamically determining the value of the resource parameter of the AMF comprises:
incrementally increasing or decreasing a currently-used value of the resource parameter of the AMF.

11. The method of claim 1, wherein dynamically determining the value of the resource parameter of the AMF comprises:
selecting the value from a set of pre-configured values.

12. A computing system to facilitate a cellular network, the computing system comprising:
one or more processing devices; and
memory communicatively coupled with and readable by the one or more processing devices and having stored therein processor-readable instructions which, when executed by the one or more processing devices, cause the one or more processing devices to perform operations comprising:
monitoring a plurality of parameters associated with an access and mobility management function (AMF) in the cellular network, the plurality of parameters being associated with a demand on performance of the AMF;
dynamically determining, based on the plurality of parameters, a value of a resource parameter of the AMF; and
adjusting one or more resources of the AMF according to the value of the resource parameter.

13. The computing system of claim 12, wherein each parameter of the plurality of parameters characterizes at least one of: a time, a geographic region associated with a data center including the AMF, a number of a plurality of user equipment (UE) served by the AMF, a state of each UE of the plurality of UE, data demand, a number of a plurality of base stations served by AMF, a capacity and status of each base station of the plurality of base stations, or traffic in an interface to the AMF.

14. The computing system of claim 12, wherein the operations further comprise:
determining whether the plurality of parameters satisfies a threshold criterion, wherein dynamically determining the value of the resource parameter of the AMF is performed responsive to determining that the plurality of parameters satisfies the threshold criterion.

15. The computing system of claim 12, wherein dynamically determining the value of the resource parameter of the AMF comprises:
predicting a reference value of the resource parameter of the AMF based on historical data, wherein the reference value is weighted to be used with the plurality of parameters to determine the value of the resource parameter of the AMF.

16. One or more non-transitory, computer-readable storage media having computer-readable instructions thereon which, when executed by one or more processing devices, cause the one or more processing devices to perform operations comprising:
monitoring a plurality of parameters associated with an access and mobility management function (AMF) in a cellular network, the plurality of parameters being associated with a demand on performance of the AMF;
dynamically determining, based on the plurality of parameters, a value of a resource parameter of the AMF; and
adjusting one or more resources of the AMF according to the value of the resource parameter.

17. The one or more non-transitory, computer-readable storage media of claim 16, wherein each parameter of the plurality of parameters characterizes at least one of: a time, a geographic region associated with a data center including the AMF, a number of a plurality of user equipment (UE) served by the AMF, a state of each UE of the plurality of UE, data demand, a number of a plurality of base stations served by AMF, a capacity and status of each base station of the plurality of base stations, or traffic in an interface to the AMF.

18. The one or more non-transitory, computer-readable storage media of claim 16, wherein the operations further comprise:
determining whether the plurality of parameters satisfies a threshold criterion, wherein dynamically determining the value of the resource parameter of the AMF is performed responsive to determining that the plurality of parameters satisfies the threshold criterion.

19. The one or more non-transitory, computer-readable storage media of claim 16, wherein dynamically determining the value of the resource parameter of the AMF comprises:
incrementally increasing or decreasing a currently-used value of the resource parameter of the AMF.

20. The one or more non-transitory, computer-readable storage media of claim 16, wherein dynamically determining the value of the resource parameter of the AMF comprises:
selecting the value from a set of pre-configured values.
